(19) United States
(12) Patent Application Publication
(10) Pub. No.: US 2015/0180310 A1
(43) Pub. Date: Jun. 25, 2015

(54) ELECTRIC ENERGY GENERATOR DEVICE AND OPERATING METHOD

(71) Applicants: Ricardo Gabriel Vanella, Buenos Aires (AR); Horacio Marcelo Fabián Pacheco, Buenos Aires (AR); Ciro Alejandro Rodríguez, Buenos Aires (AR); María Claudia Rodríguez, Buenos Aires (AR)

(72) Inventors: Ricardo Gabriel Vanella, Buenos Aires (AR); Horacio Marcelo Fabián Pacheco, Buenos Aires (AR); Ciro Alejandro Rodríguez, Buenos Aires (AR); María Claudia Rodríguez, Buenos Aires (AR)

(21) Appl. No.: 14/270,960

(22) Filed: May 6, 2014

(30) Foreign Application Priority Data
Dec. 19, 2013 (AR) 20130104875
Apr. 4, 2014 (AR) 20140101495

(51) Int. Cl. H02K 7/18

(52) U.S. Cl. CPC H02K 7/1853; Y10S 74/09; F03G 7/10

(57) ABSTRACT

The device includes components that, through an associated work, are capable of transforming mechanical energy into electric energy, using inertial and gravitational effects. The device includes a base structure with an axial part, to which a rotary support structure is rotatably mounted, moved through a driving means that drives its spinning movement over the axial part. An electric generators system and a rotating guidance system is mounted to the rotary support structure, and an inertial rotation structure that includes an inertial load is rotatably mounted to the rotating guidance system. The inertial rotation structure drives the electric generators. An operating method by which the device is started up and its electric generators system is operated is also provided.

### FIELD OF THE INVENTION

The present invention relates generally to energy and electric energy generation from mechanical energy.

### BACKGROUND

As time passes and we enter into a new era the survival of the human being and future comfort of living should be considered. As a result of this thought, the following question, which is simple but has a potentially problematic response, arises:

Why isn't the potential for producing energy from the earth's gravity being implemented or investigated?

In order to create and invent these devices, different circumstances have to take place. This system is capable and possible as it arises from the practical and schematic appreciation, using a series of electric generators that are arranged in ring-shape and take force from a structure that spins boosted by a driving means and by gravity effect.

It is worth remembering that, according to the first law of thermodynamics, “energy is not created nor destroyed, but only transformed”. This is an empirical law based on observation. However, this does not invalidate the use of coadjuvant forces, as can be observed in different experiences, such as where NASA accelerates its ships using planetary gravities to acquire speed.

Humanity knows many experiences of effective use of different phenomenon, such as atomic orbits and movements. Or the simple games and curiosities that are always moving. It involves finding the best ways and means to reach such use.

At one point, a group of 18 brilliant minds were invited by the National Academy of Engineering and called to prepare a list of the technological problems of the 21^{st} century that, if solved, would lead to improvements in human existence.

The group focused on the study of four specific areas to try to enumerate the problems of the current world:

1. Sustainability.

2. Health.

3. Vulnerability.

4. Joy of living.

In the beginning of their report they wrote the following:

“As world population grows, their necessities and wishes also grow, the problem of maintaining the continuous advance of civilization and improving quality of life of people gets more important.”

One of the priorities set by the group was to obtain sources of clean energy, together with the maximization of the ability to reverse the effects of age in the human body.

They went on stating that the reprogramming of the human genes to prevent diseases is essential, and that also in the near future a solution on how the vulnerable human life on earth is affected by natural disasters and terrorists violence should be found.

They specifically explained that drinking water will be missing and that, in order to retrieve this, it is necessary to implement efficient, safe and economical mechanisms to desalinate sea water.

For the latter, it would be necessary to have unlimited, economical and highly available energy sources.

### ADVANTAGES OF CERTAIN EMBODIMENTS

Embodiments of the present invention include a machine that transforms energy (mechanical and gravitational energy) into electric energy (output energy), that operates by varying the tilt of a rotary support structure with an inertial rotation structure that transmits spinning force into a group of alternators.

In certain embodiments, due to the particulars of its operation, the device can be installed and located on any continental land surface, underground or underwater surfaces. The ability to place the device in a variety of different places allows one to consume electric energy near the place where the energy is generated.

Embodiments of the present invention take advantage of the following:
1. Earth's gravity and inertial effect, which we know is found throughout the planet.
2. An efficient use of its component structures.
3. Different mechanisms proven to be suitable.

In order to operate, embodiments of the present invention do not require:
1. Additional electric energy generated by other devices, except for the one necessary to exit its initial rest state and for the energy required to move its structure.
2. Any type of fuel, either from known fossil or artificial chemical origin.
3. Atmospheric air.
4. Sun energy.
5. Wind.
6. Hydraulic force of reservoir water.
7. Sea currents or swell.
8. Energy contained in volcanoes.
9. Geothermal energy.
10. Atomic energy.

Among the advantages of certain embodiments of the present invention, the following can be mentioned:

1. In embodiments of the present invention, elements of the device are distributed in such a way as to generate an unparalleled advantage from the point of view of energy generation.

2. In embodiments of the present invention, the construction of the device allows the device to be placed in a variety of different places. Thus, for example, the device can be placed where energy generation is necessary according to demand to cover necessities, or the device may be placed where its functional presence is strategically undetectable in order to avoid malicious attacks to the device.

3. In embodiments of the present invention, the physical size of the device may be varied proportionally according to energy consumption. In other words, the size can be calculated according to the magnitude of demand required.

4. Embodiments of the present invention produce energy economically. Once the initial investment is made, the costs associated with the device are limited.

5. Electricity is typically generated at a distance far from the place of actual consumption, and the means by which the electricity is transported is inefficient and expensive. In embodiments of the present invention, this device can be incorporated into a system that is independent of transport systems that transport energy long distances, since the device can be located in the same place or near to the place where energy is going to be consumed.

6. In the building of the present device, known materials of elements of nature are used. These materials are noble and with the proper use during the manufacturing are capable of giving very important characteristics such as scarce mechanical or material maintenance during time of operation.

7. Embodiments of the present invention can stably produce energy, and as mentioned previously, the size can be set previously so that such production is appropriate to cover the required demand. Additionally, in embodiments of the present invention, when a large amount of electric energy is required, a group of small units or a single large unit with appropriate dimensions can be provided.

Once an initial boost has been given, with an X cost of external energy, in order to maintain operation, the only requirement is a minimum necessary quantity of energy to keep the device operating. This considers the necessary energy to overcome resistance by frictions and also foresees the possibility of eventually using part of the electric energy generated for the necessities of the system.

This generator device is capable of producing large quantities of electric energy, using only the energy required for its operating that, in view of its efficiency, is reduced to the minimum necessary, which is available in its location.

### BRIEF DESCRIPTION OF THE DRAWING FIGURES

For better clarity and understanding, an embodiment is illustrated with several figures, everything as an illustrative example, without limitation:

FIG. 1 is an upper perspective view of an electric energy generator device according to an embodiment of the present invention.

FIG. 2 is a perspective exploded view of the electric energy generator device according to an embodiment of the present invention, which allows the appreciation of the different component parts separately.

FIG. 3 includes drawings A and B, being:

Drawing A, a perspective view of the electric energy generator device according to an embodiment of the present invention in which the hydraulic arm of the driving means is retracted and

Drawing B, another perspective view of the electric energy generator device according to an embodiment of the present invention in which the hydraulic arm of the driving means is extended, causing the tilt of the rotary support structure.

FIG. 4 includes drawings A, B and C, being:

Drawing A, a perspective view of the guider support that includes the rotating guidance system according to an embodiment of the present invention;

Drawing B, a side elevation view, of the guider support according to an embodiment of the present invention; and

Drawing C, another side elevation view, of the guider support with the upper and lower reinforcements and the inertial structure indicated in cross-section according to an embodiment of the present invention.

FIG. 5 includes drawings A, B and C, being:

Drawing A, a perspective view of an electric generator according to an embodiment of the present invention;

Drawing B, a side elevation view of an electric generator according to an embodiment of the present invention; and

Drawing C, another side elevation view of the electric generator related to the inertial structure indicated in cross-section according to an embodiment of the present invention.

FIG. 6 includes drawings A, B and C, being:

Drawing A, a perspective view of a utility support that integrates the rotating guidance system according to an embodiment of the present invention;

Drawing B, a side elevation view, of the utility support according to an embodiment of the present invention; and

Drawing C, another side elevation view of the utility support related to the inertial structure, indicated in cross-section according to an embodiment of the present invention.

FIG. 7 includes drawings A, B, C and D, being:

Drawing A, a perspective side view that shows the driving arm extended and causing the tilt of the rotary support structure according to an embodiment of the present invention;

Drawing B, an upper plain view, of the electric energy generator device according to an embodiment of the present invention in which the inertial rotation structure has exceeded the zenithal limit of rotation;

Drawing C, another perspective side view of the electric energy generator device according to an embodiment of the present invention that shows the driving arm retracted and boosting (or driving) the horizontal position of the rotary support structure; and

Drawing D, another upper plain view, of the electric energy generator device according to an embodiment of the present invention in which the inertial rotation structure is near the zenithal limit of rotation.

FIG. 8 is an upper plain view, of the electric energy generator device according to an embodiment of the present invention in which the inertial rotation structure is shown in a position where the fixed and mobile components of the sensor system of positional detection are facing each other. The dashed arrow indicates the direction of rotation of the inertial rotation structure.

FIG. 9 is another upper plain view of the electric energy generator device according to an embodiment of the present invention in which the inertial rotation structure is shown in another position.

FIG. 10 is another upper plain view of the electric energy generator device according to an embodiment of the present invention in which the inertial rotation structure is shown in another position.

FIG. 11 includes drawings A and B, being:

Drawing A, a longitudinal cut of the accessories cabinet according to an embodiment of the present invention and

Drawing B is another longitudinal cut of the accessories cabinet according to an embodiment of the present invention, where the sensor system of positional detection and the start up engine can be seen.

FIG. 12 is a schematic representation of the operation of the electric energy generator device according to an embodiment of the present invention.

FIG. 13 is a schematic representation of the connections between the main circuits and parts of the electric energy generator device according to an embodiment of the present invention.

In the different figures, the same numbers and/or reference letters indicate equal or corresponding parts.

### LIST OF THE MAIN REFERENCES

(1) Base structure.
(10) Principal Base.
(11) Axial Supports.
(12) Bearings of the axial supports (11).
(13) Axial part (Shafts or rotating shafts).
(2) Rotary support structure.
(20) Rotating mounting.
(21) Structure coaxial frames (2).
(22) Structure triangular frames (2).
(23) Levelers.
(24) Ring Support.
(25) Lower mounting reinforcement.
(26) Upper reinforcement.
(3) Driving unit [boosts the spinning movement of the rotary support structure (2)].
(30) Hydraulic arm of variable length.
(30a) Retracted hydraulic arm.
(30b) Extended hydraulic arm.
(31) Hydraulic circuit [installation and/or equipment and/or hydraulic group].
(4) Guidance system.
(40) Guider support.
(41) Guider base.
(42) Guider extremity.
(43) Rotating guidance.
(44) Upper bearings.
(45) Side bearings.
(46) Utility support.
(47) Utility shaft.
(48) Drive bearings.
(5) Electric generators systems.
(50) Electric generators.
(51) Electric generators legs.
(52) Generator shaft [coupable to the utility shafts (47)].
(6) Inertial rotation structure.
(60) Main body of the structure.
(61) Guided ring member.
(62) Eccentric body of inertial load.
(63) Inertial load regulator.
(64) Inertial load receptacles.
(65) Inertial load units.
(67) Zenithal or upper limit of rotation [between the ascendant rotation and the descendent rotation of the inertial rotation structure (6)].
(68) Lower limit of rotation [between the descendent rotation and the ascendant rotation of the inertial rotation structure (6)].
(7) General electric/electronic circuit.
(70) General command panel.
(71) Ring conduit.
(72) Exterior conduit.
(8) Sensor system of positional detection.
(81) Fixed components of the system (8).
(810) Transmitter.
(811) Receiver.
(82) Mobile components of the system (8) [refractory].
(9) Start up device.
(90) Moving mechanism [start up engine].
(91) Conductor coupling [of start up].
(92) Coupling/decoupling system.
(93) Driving or start up circuit.
(100) Synchronization device.
(101) Interface [between the sensor system of positional detection (8) and the driving means (3)].
(102) Synchronization circuit.
(120) Interface.
(130) Accessories cabinet.

### DESCRIPTION

Embodiments of the present invention include an electric energy generator device that, from external energy received, transforms this energy into mechanical energy, which use is improved through a system based on spinning and rotating structures that, finally, boost or drive a system of electric generators. Embodiments also include an operating method in which the electric energy generator is started and maintained in proper working order.

In some embodiments, an electric energy generator device includes components that, through associated work, are capable of transforming mechanical energy into electric energy using inertial and gravitational effects. The electric energy generator includes a base structure (1) with an axial unit (3), in which a rotary support structure (2) is rotatably mounted, moved through a driving means (3) that boosts (or drives) its spinning movement over the axial media (13). The rotary support structure (2) provides the mounting, both for the electric generators (50) system (5), and for a rotating guidance (43) system (4), in which an inertial rotation structure (6) that includes an eccentric inertial load (65) is rotably mounted. The inertial rotation structure (6) is the boosting or driving means of the electric generators (50).

### DETAILED DESCRIPTION

Reference will now be made to the accompanying drawings, which form a part hereof, and which show, by way of illustration, specific exemplary embodiments. The principles described herein may, however, be embodied in many different forms. The components in the figures are not necessarily to scale, emphasis instead being placed upon illustrating the principles of the invention. Moreover, in the figures, like referenced numerals may be placed to designate corresponding parts throughout the different views.

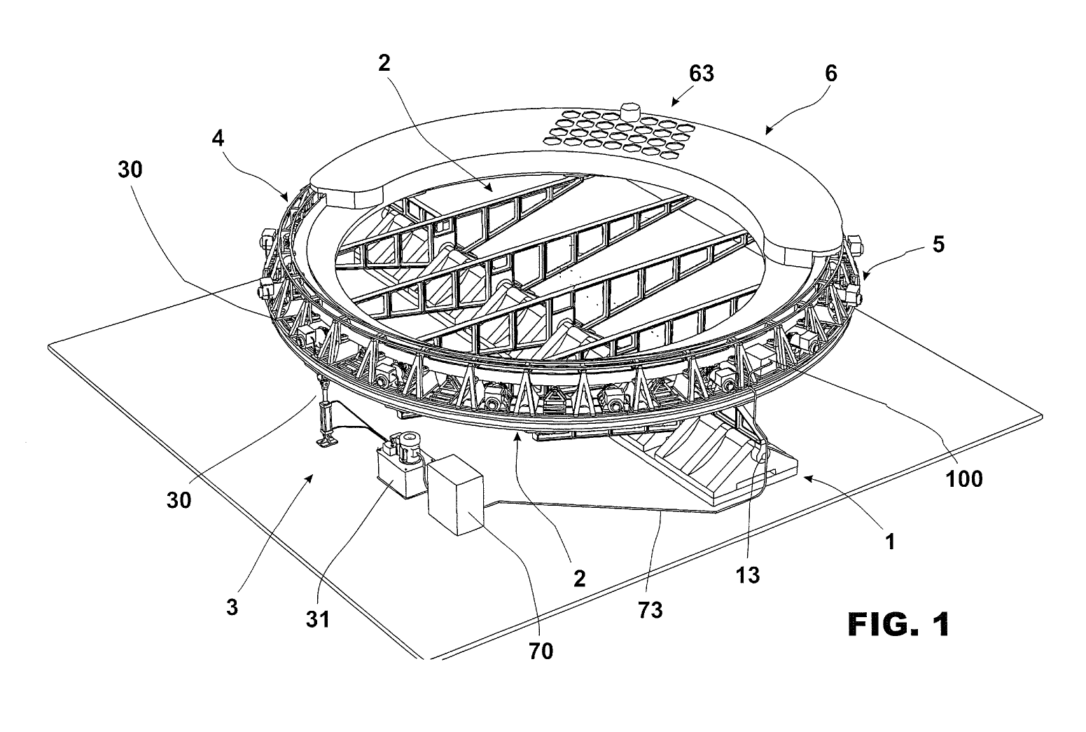

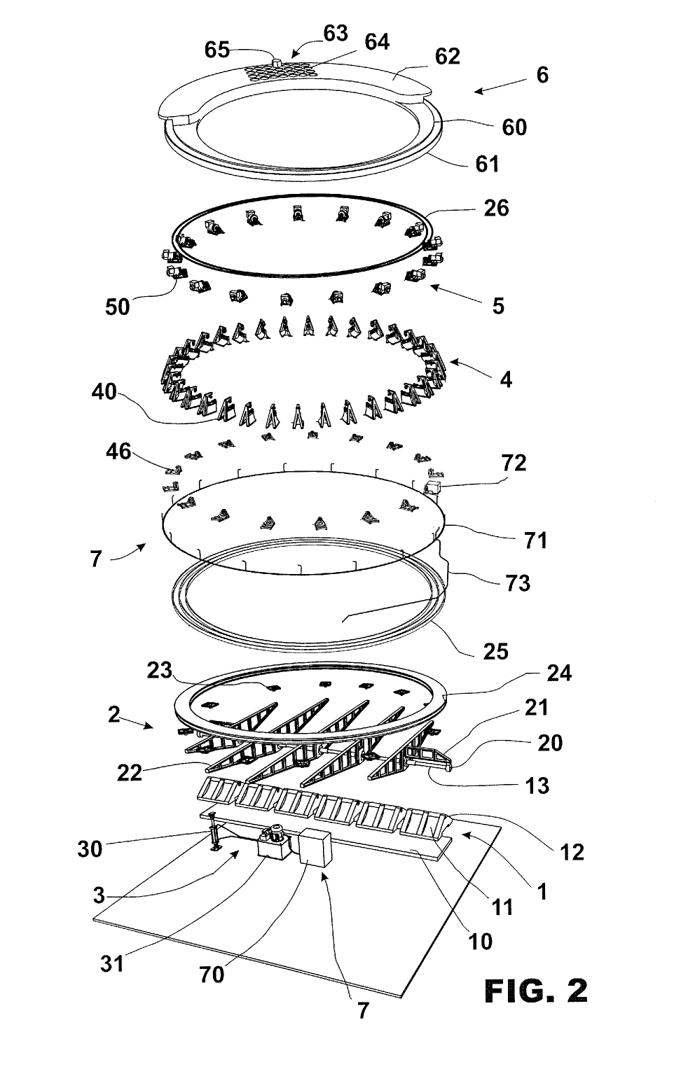

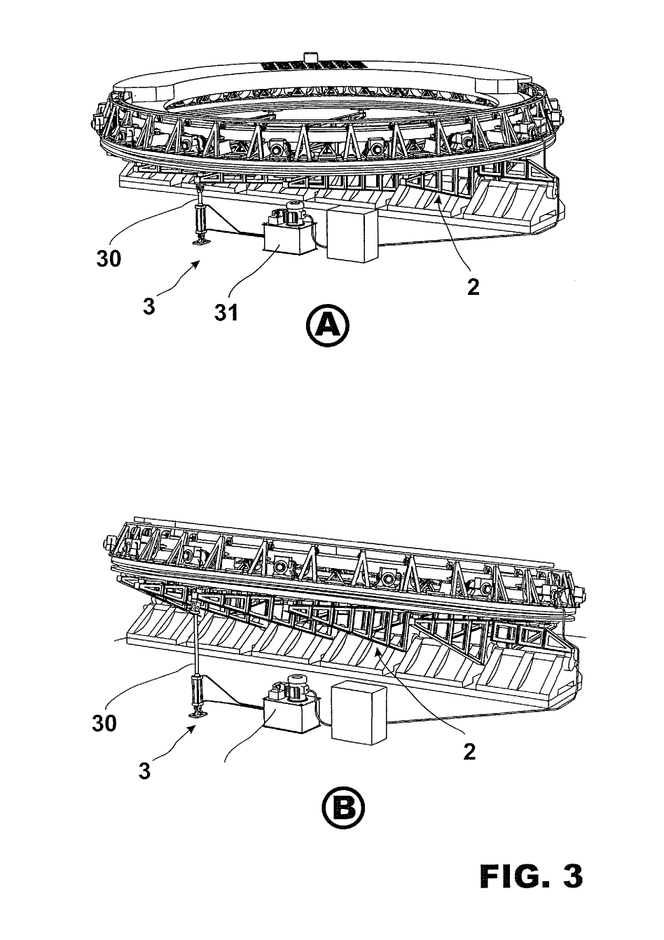

Referring now to FIGS. 1-3, the electric energy generator includes a base structure (1) with an axial part (13). The axial part may, for example, include only one shaft or many coaxial shafts. A rotary support structure (2) is mounted over the axial part (13).

The rotary support structure (2) is under the influence of a driving unit (3) that boosts or drives its spinning movement over the axial part (13).

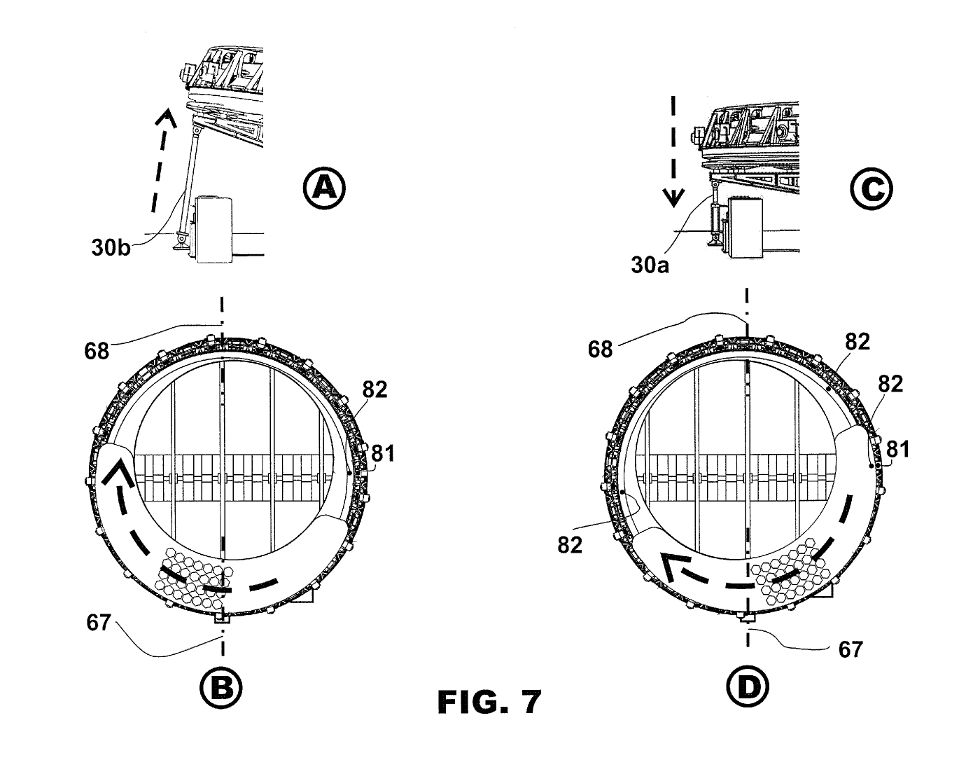

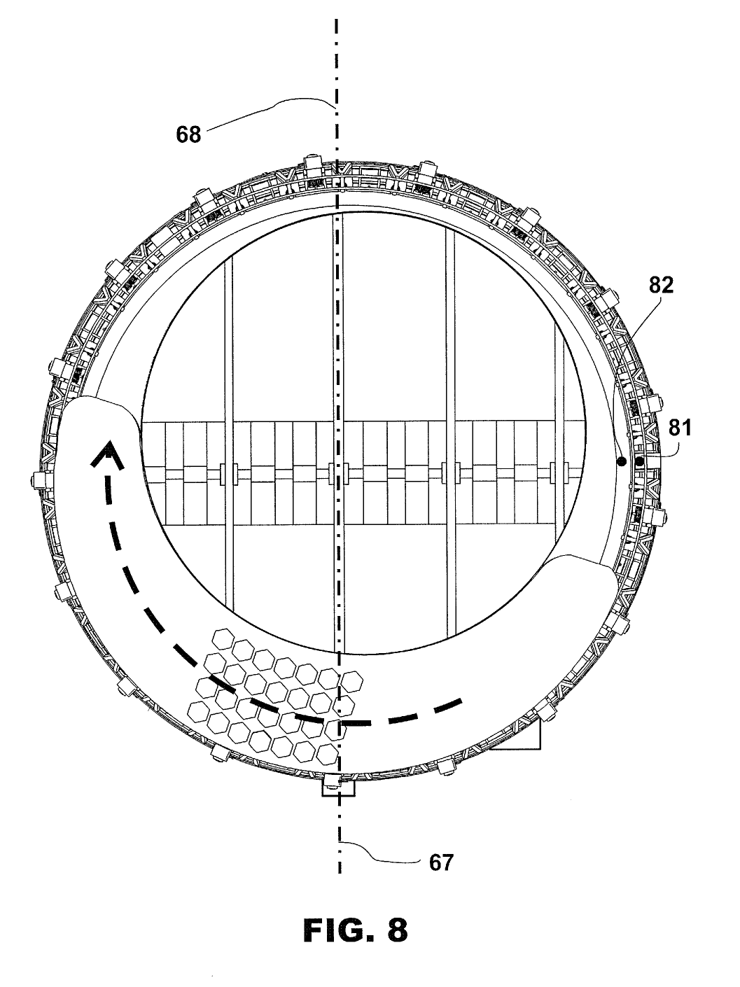

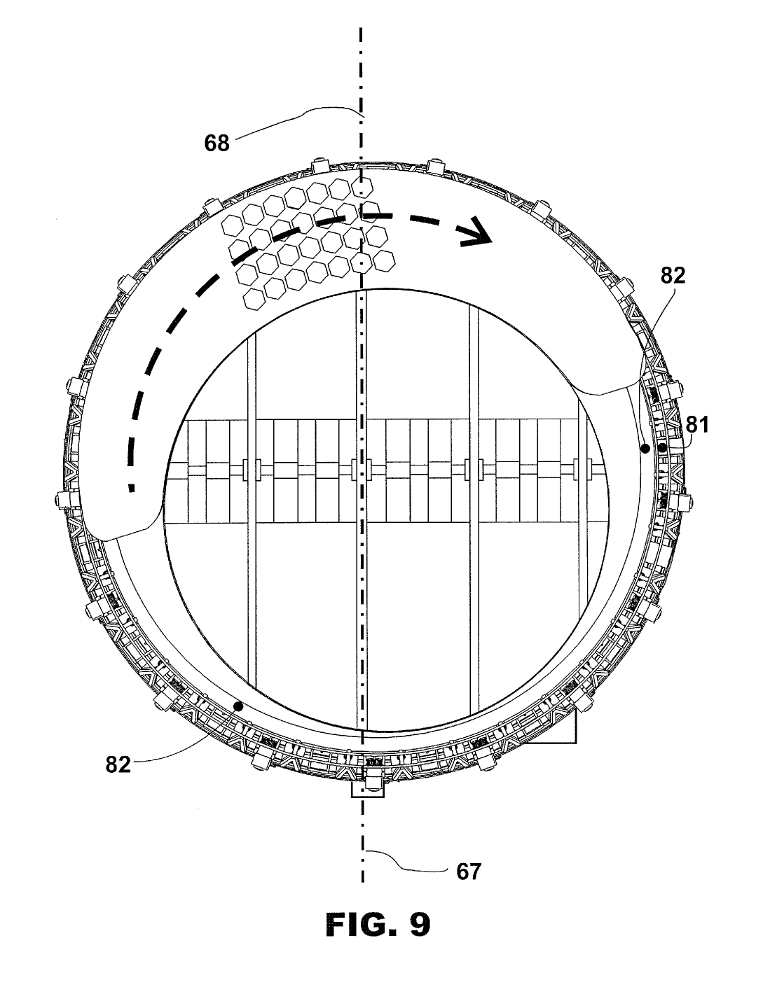

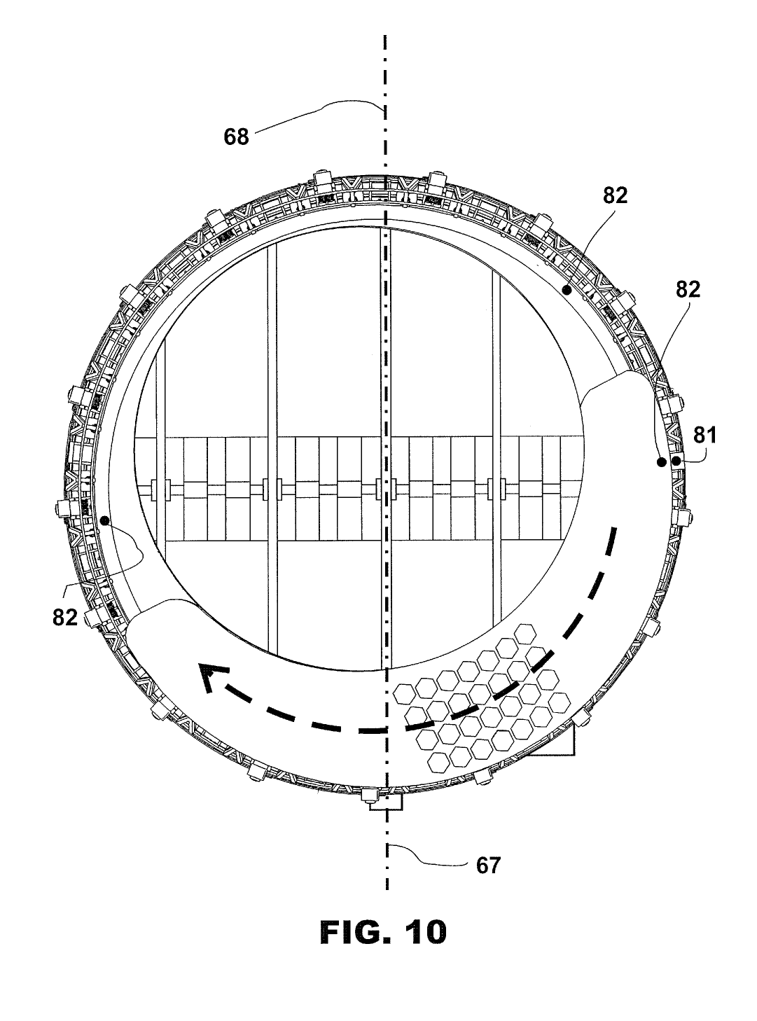

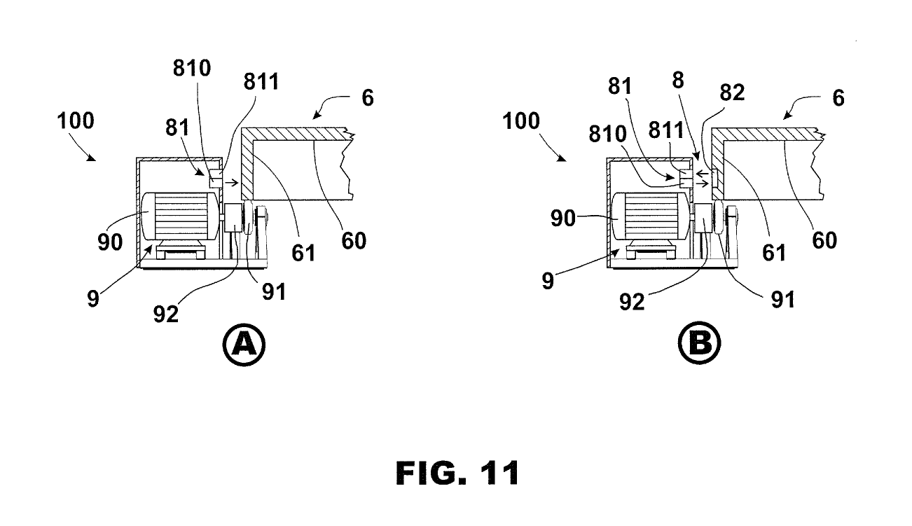

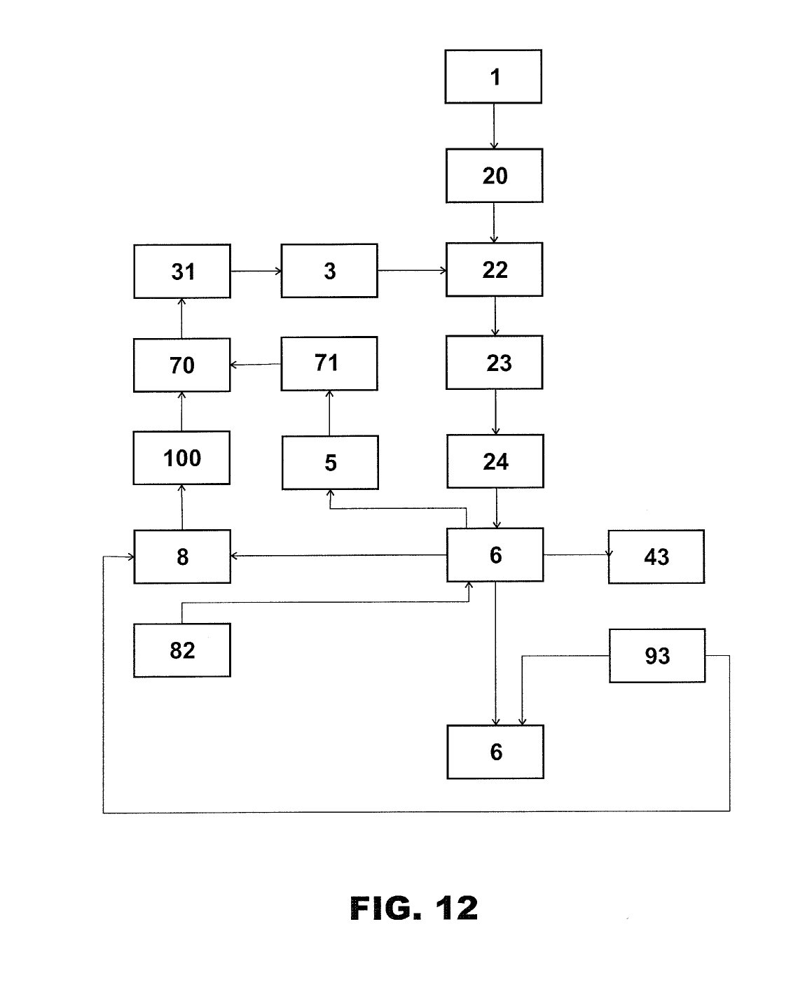

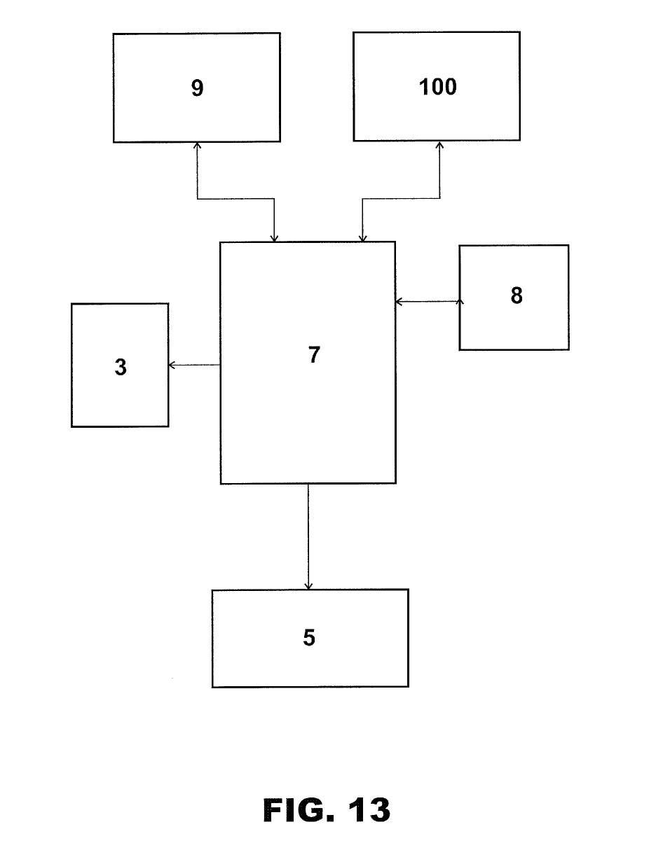

In an embodiment, the driving unit (3) may comprise any system that, externally driven, is capable of making said rotary support structure (2) rotate alternatively, in one sense and another. The driving unit may comprise a variable length arm. The variable length arm may comprise a hydraulic arm of variable length (30) mounted on a hydraulic cylinder. For example, referring to FIG. 7, the hydraulic arm of variable length 30 may be in an extending state (30b) such that the rotary support structure tilts or in a retracted state (30a). In an embodiment, the hydraulic arm of variable length (30) integrates a hydraulic circuit (31) of service. The expression hydraulic circuit refers to the installation, equipment and/or hydraulic group used for the desired effect.

Referring to FIGS. 1-5, in an embodiment, an electric generators system (5) and a guidance system (4) are mounted on the rotary support structure 2.

The rotary support structure (2) includes a rotating mounting (20) in the axial part (13), and a ring support (24) over which a lower mounting reinforcement (25) is arranged.

In an embodiment, the rotary support structure (2) may have a mainly skeletal constitution integrated by triangular frames (22) or others.

Furthermore, the rotary support structure (2) includes levelers (23) that link in a functional adequate manner the skeletal part with the ring support (24). This ring support (24) may have, for example, a profile in horizontal “H”.

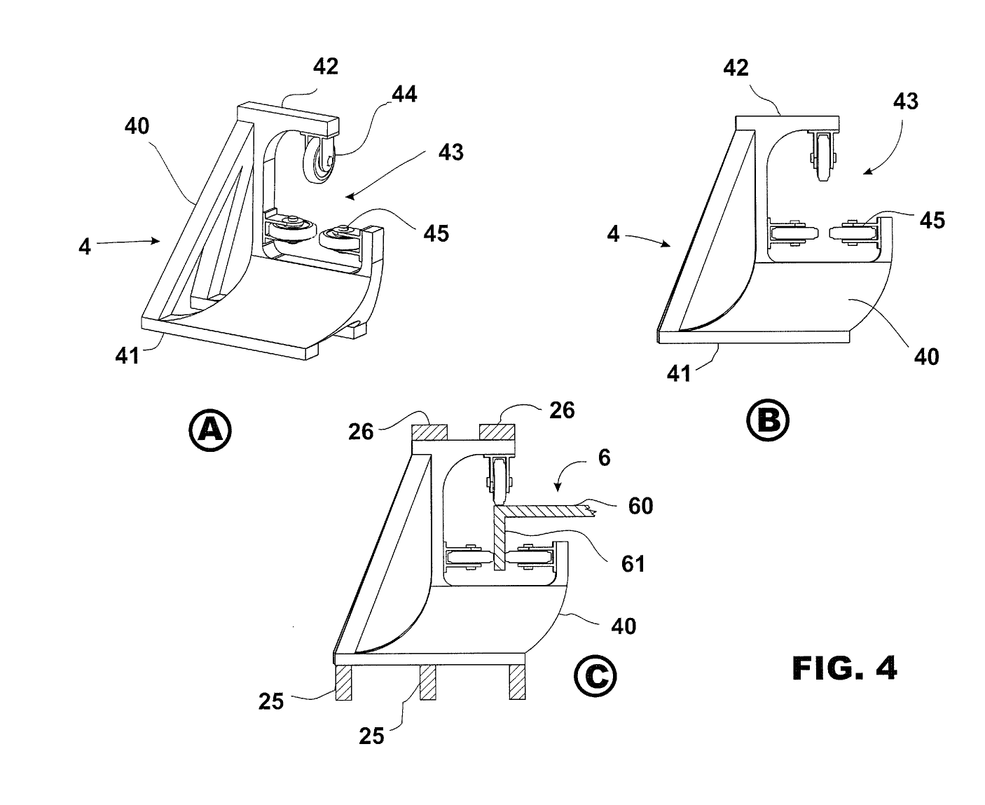

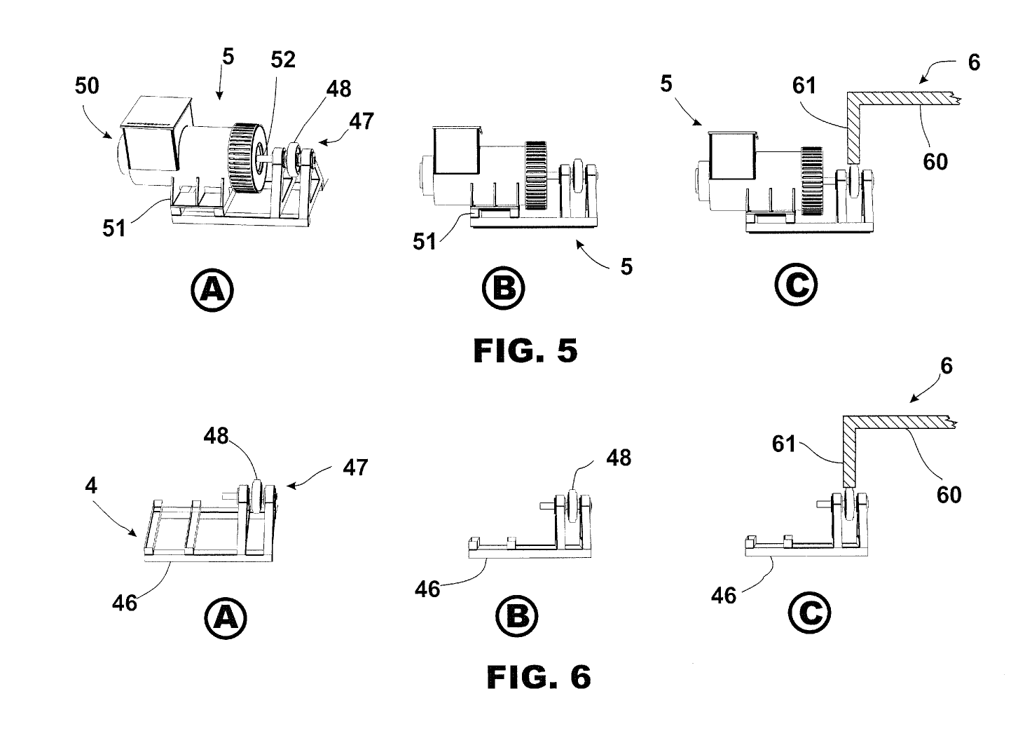

Both the guidance system (4) and the electric generators (50) system (5) are mounted over the rotary support structure (2). The guidance system 4 and the electric generators system 5 are shown in more detail in FIGS. 4 and 5.

An inertial rotation structure (6) that includes an eccentric inertial load (65) is mounted on the guidance system (4).

Referring to FIGS. 4A-4C, in an embodiment, the guidance system (4) includes a set of guidance supports (40) provided with both bearings sets (44) (45) that delimit the passage of the rotating guidance (43), through which the guided member (61) of the inertial rotation structure (6) passes.

In an embodiment, each guider support (40) includes, at least, one set of side bearings (45) and a set of upper bearings (44).

Referring to FIGS. 5A-6C, in an embodiment, the guidance system (4) includes, at least, a set of structures or utility supports (46) that include, at least, one drive bearing (48) capable of forming the rotating guidance (43) passage.

In an embodiment, each utility structure includes a utility support (46) capable of supporting an electric generator (50) whose shaft (52) couples with the drive bearing (48).

In an embodiment, the inertial rotation structure (6) is the boosting or driving means of such electric generators (50). For example, movement of the inertial rotation structure (6) provides the mechanical energy which the electric generators (50) convert to electric energy.

Referring to FIGS. 1-3, the inertial rotation structure (6) includes an inertial load regulator (63) that, for example, may include receptacles (64) capable of receiving both inertial load units (65).

The electric energy generator device may have one or more electric/electronic circuits (7) both for its operation and for the transmission of the generated electric energy, as well as for the eventual partial use in the automatic operation of the generator device.

Referring to FIGS. 8-11, in an embodiment, a start up device (9) includes a driving circuit (93), connection with a sensor system of positional detection (8) [that allows the control of the inertial rotation structure position (6)] and a moving mechanism (90) capable of moving the inertial rotation structure (6) until it reaches a predetermined start up position.

The connection or link with the sensor system of positional detection (8) allows for detection of the position of the inertial rotation structure (6). Once the driving circuit (93) is activated, the moving mechanism (90) moves the inertial rotation structure (6) until a predetermined start up position. In other words, the moving mechanism (90) moves the inertial rotation structure (6) to a predetermined start up position.

The sensor system of positional detection (8) includes fixed components (81) that are mounted in the rotary support structure (2) and mobile components (82) located in the inertial rotation structure (6). In different embodiments, any type of sensors (capacitive, inductive, photoelectric, magnetic, infrared, reflector or refractory detectors, etc.) suitable for the desired effect, which is controlling the position of the above-mentioned inertial rotation structure (6), may be used.

In an embodiment, the electric energy generator device also includes a synchronization device (100) for its automatic operation. This synchronization device (100) uses the sensor system of positional detection (8), an interface (101) [that links the sensor system of positional detection (8) with the driving means (3)] and a synchronization circuit (102), so that the driving means (3) controls the tilt of the rotary support structure (2) in a synchronized manner with the position and rotating movements of the inertial rotation structure (6).

In this way, the gravitational effect is used increasing or decreasing the tilt of the rotary support structure (2), after the inertial rotation structure (6) has exceeded the zenithal (67) or lower (6) limits of rotation.

In this regard, the zenithal limit (67) refers to the limit that, in the sense of rotation, separates the ascendant rotation from the descendent rotation of the inertial rotation structure load (6), in the ascendant tilt conditions of the rotary support structure (2) on the part of the driving unit (3). Furthermore, lower limit (67) refers to the limit that, in the sense of rotation, separates the descendent rotation from the ascendant rotation of the inertial rotation structure load (6), in the descendent tilt conditions of said structure of rotating support (2) from the above-mentioned driving unit (3).

In short, the part of the automatic driving allows the control of the driving means (3) to produce the necessary movements of the rotary support structure (2), required for the operation of the inertial rotation structure (6) and the driving of the electric generators (50).

### Operation:

The automation of the device allows the synchronization between the rotation movement of the inertial rotation structure (6) and the linear movements of the hydraulic arm (30), between its two extreme positions in which it is extended (30b) or retracted (30a).

More particularly, the linear ascendant and descendent movements of the above-mentioned hydraulic arm (30) are synchronized with the rotation movements of the inertial rotation structure (6), through a synchronization device (110).

This synchronization device (110) includes a sensor system of positional detection (8), an interface (120) and the driving means (3).

The driving means (3) controls the tilt of the rotary support structure (2), in a synchronized manner with the signals from the sensor system (8). In this way, the hydraulic arm (30) is unfolded until its extended position (30b) and boosts or drives the structure of the rotating support (2) to its maximum tilt, after the inertial rotation structure (6) exceeds the zenithal limit (67). In this zenithal limit (67), the inertial rotation structure (6) moves from its stroke of ascendant rotation to its stroke of descendent rotation, using the gravitational effect and the tilt of the above-mentioned rotary support structure (2).

As the inertial rotation structure (6) approaches the lower rotation limit (68), the hydraulic arm (30) is retracted until its retracted position (30a) moving the rotary support structure (2) to a horizontal or of minimal tilt position. The lower rotation limit (68) is where the inertial rotation structure (6) moves from its stroke of descendent rotation to its stroke of ascendant rotation. These movements are facilitated by the decrease of the tilt and the subsequent mitigation of the gravitational effect over the inertial rotation structure (6).

In an embodiment, the start up device (9) includes a driving circuit (93), connection with the sensor system of positional detection (8) and moving mechanism (90) [start up engine] capable of moving the inertial rotation structure (6). The connection or link with the sensor system of positional detection (8), allows the location of the position of the inertial rotation structure (6). Once the driving circuit (93) is activated, the start up engine (90) boosts (or moves) the inertial rotation structure (6) to a predetermined start up position. In an embodiment, once the predetermined start up position is reached, the above-mentioned start up engine (90) has a coupling/decoupling system (92) that allows decoupling to release the operation of the inertial rotation structure (6).

Preferably, the start up position should be that in which the above-mentioned inertial rotation structure (6) has exceeded the zenithal limit (67) and stays in a position in which, the extension (30b) of the hydraulic arm (30), allows the maximum use of the gravitational effect during the start up of the device.

### Example

An example of the operation of an embodiment is described below. In order to operate the electric energy generator device, we begin from rest state and then all the activity is focused on maintaining one movement condition as uniform as possible in time, as the different internal and external factors affect it.

The inertial rotation structure (6) has an inertial load (65) that makes it acquire rotation movements when the rotary support structure (2) is tilted by action of the hydraulic arm (30).

Through the movement sensors system (8) we may manage the activity developed by the hydraulic arm (30), so that the desired synchronization is achieved.

The synchronization, for example, can be defined in three magnitudes, always taking as rotation direction from the upper plain view, the clockwise rotation.
1. Time: represented in how many magnitudes the inertial rotation structure (6) takes to complete a turn.
2. Space: represented in the position of a fixed point in the inertial rotation structure (6), in relation to the fixed point in which the mobile components (82) of the sensor system (8) are.
3. Periodicity: represented by the interrelation of above two items, mainly in the uniform repetition of the movements over time.

In an embodiment, infrared photocells may be used as the movement sensors system 8. In such an embodiment, the following points may be assigned:

1. A plurality of fixed points in the inertial rotation structure (6) represented each by a refractory part (82) of the infrared sensors and arranged in each side of the inertial rotation structure (6), which passes very close to the where the fixed components (81) of the system are located.

2. A plurality of fixed points (i.e., the fixed components (81)) in the support ring, represented each by a transmitter (810) of infrared light and the receiver (811) of the photocell that receives the rebound of the infrared beam.

At the same time, in the embodiment two positions derived from the activity of the hydraulic arm (30) may be defined:

1. Retracted position (30a) in which the hydraulic arm (30) is not extended.

2. Extended position in which the hydraulic arm (30) is completely extended.

In the embodiment, the logic sequence of automation would be the following:
1. By means of the manual activation of a driving circuit in the general command panel (70), the input of external electric energy to start up electric engine (90) is enabled, placed inside the accessories cabinet (130), which function is making the inertial rotation structure (6) rotate, until it reaches the optimum position for the subsequent leaving of the rest state. The inertial rotation structure (6) is brought to its start up position, while the rotary support structure (2) is in horizontal position, due to the fact that the hydraulic arm (30) is retracted (30a). Once the refractory mobile component (82) reaches the position in which it faces the fixed components (81), the receiver (811) receives the emission from the transmitter (810) and a signal that deactivates the start up engine (90) is generated, and the rotation movement of the rotary support structure (2) stops, whereby the device is positioned to initiate the rotation movement automatically.
2. At the same time that the activity of the start up engine (90) is stopped, the activity of the hydraulic arm (30) is initiated. A signal received by the hydraulic circuit (31) whose operation allows the hydraulic arm (30) to move from its retracted position (30a) to its extended position (30b).
3. As the hydraulic arm (30) reaches the extended position (30b), the rotary support structure (2) is tilted and, as a consequence, the inertial rotation structure (6) rotates clockwise (as can be seen in FIGS. 7 to 10).
4. The rotation movement continues until the refractory (82) faces the fixed components (81) of the sensor system (8). At this point, a signal is generated so that the hydraulic circuit (31) retracts the hydraulic arm (30) so that it moves from its extended position (30b) to the retracted position (30a).
5. As the hydraulic arm (30) reaches the retracted position (30a), the rotary support structure (2) is tilted and as a consequence the inertial rotation structure (6) rotates clockwise.
6. The rotation movement continues until the refractory (82) faces to the fixed components (81) of the sensor system (8). At this point, a signal is generated so that the hydraulic system (31) extends the hydraulic arm (30) so that it moves from the retracted position (30a) to the extended one (30b).

The described actions are automatically repeated while the device is in normal operation.

In an embodiment, the general command panel (70) can have one or more switches that, in different places, allow the interruption of the sequence of operation of the sensor system (8), moving the system to the immediate rest state.

In an embodiment, the general electric/electronic circuit (7) has protection systems and systems of derivation of the produced electric energy to the external part of the system.

### Operating Method:

A method of operating the electric energy generator device according to an embodiment of the invention is as follows:

First, the start up device (9) is driven. Through the sensor system (8) the position of the inertial rotation structure (6) is controlled and the driving means (3) is retracted to reduce the tilt of the rotary support structure (2).

Through the moving means or start up engine (90), the inertial rotation structure (6) is rotated until it reaches a predetermined start up position that, in the sense of rotation, is beyond the zenithal limit (67).

Then the driving means (3) [arm (30)] is extended (39b) to increase the tilt of the rotary support structure (2) and submit the inertial rotation structure (6) to the gravitational effect, that makes it rotate over above-mentioned rotary support structure (2).

Once the device has been started up, the position of the inertial rotation structure (6) is controlled through a sensor system (8) and the operation of the driving means (3) [from the rotary support structure (2)] and of the inertial rotation structure (6) are synchronized.

During the extension (30b) of the arm (30) [driving means (3)], synchronization is such that the arm (30) reaches its maximum extension (30b) after the eccentric inertial load (62) exceeds, in the sense of rotation, the zenithal limit (67) between the ascendant rotation and its descendent rotation over the rotary support structure (2).

During the retraction (30b) of the arm (30), synchronization is such that the arm (30) reaches its maximum retraction (30a) after the eccentric inertial load (62) exceeds, in the sense of rotation, the lower limit (68) between its descendent rotation and the ascendant rotation over said rotary support structure (2).

During this operation, the generation of electric energy and its delivery outside the system are controlled.

While various embodiments of the invention have been described, it will be apparent to those of ordinary skill in the art that many more embodiments and implementations are possible within the scope of the invention. Accordingly, the invention is not to be restricted.

What is claimed is:

1. An electric energy generator device capable of transforming mechanical energy into electric energy, comprising:
a base structure comprising an axial part;
a rotary support structure rotatably mounted on the axial part;
a driving unit controlling a tilt of the rotary support structure to promote a spinning movement of the rotary support structure
an electric generator system and a rotating guidance system provided on the rotary support structure
an inertial rotation structure that includes an inertial load, the inertial rotation structure being rotatably mounted on the rotating guidance system;
wherein the driving unit controls the tilt of the rotary support structure such that the inertial rotation structure is influenced by a gravitational effect; and
wherein the electric generator system is driven by the inertial rotation structure.

2. The electric energy generator device of claim 1, wherein the rotary support structure comprises:
a rotating mounting in the axial part; and
a ring support over which a mounting reinforcement is arranged.

3. The electric energy generator device of claim 1, wherein the rotary support structure is a skeletal structure comprising triangular frames.

4. The electric energy generator device of claim 1, wherein the rotary support structure comprises one or more levelers that link the skeletal part with the ring support.

5. The electric energy generator device of claim 1, wherein the driving unit comprises a variable length arm.

6. The electric energy generator device of claim 1, wherein the driving unit comprises a hydraulic variable length arm.

7. The electric energy device of claim 6, wherein the hydraulic arm is controlled by a hydraulic circuit.

8. The electric energy generator device of claim 1, wherein the rotary support structure comprises a ring support having an “H” profile.

9. The electric energy generator device of claim 1, wherein the rotary support structure comprises a ring reinforcement.

10. The electric energy generator device of claim 1, wherein both the rotating guidance system and the electric generator system are mounted on the rotary support structure.

11. The electric energy generator device of claim 1, wherein the rotating guidance system includes a set of guidance supports provided with bearings sets that delimit a passage of the rotating guidance system, and a guided member of the inertial rotation structure passes through the passage.

12. The electric energy generator device of claim 11, wherein the guider support includes a set of side bearings and an upper bearing.

13. The electric energy generator device of claim 1, wherein the rotating guidance system includes a set of utility structures that include a drive bearing.

14. The electric energy device of claim 13, wherein the utility structure includes a utility support supporting an electric generator whose shaft couples with the drive bearing.

15. The electric energy generator device of claim 1, wherein the inertial rotation structure comprises an inertial load regulator.

16. The electric energy generator of claim 15, wherein the inertial load regulator includes receptacles capable of receiving an inertial load unit.

17. The electric energy generator device of claim 1, further comprising an electric circuit for the transmission of generated electric energy generated and for eventual use of the generated electric energy in automatic operation of the electric energy generator device.

18. The electric energy generator device of claim 1, further comprising a sensor system of positional detection of the inertial rotation structure that determines the automatic start up activation.

19. The electric energy generator device of claim 18, wherein the sensor system of positional detection comprises fixed components located in the rotary support structure and mobile components located in the inertial rotation structure.

20. The electric energy generator device of claim 1, further comprising a synchronization device for automatic operation, the synchronization device comprising:
a sensor system of positional detection comprising a fixed component located in the rotary support structure and a mobile component located in the inertial rotation structure.
an interface between the sensor system and the driving unit; and
wherein the driving unit controls the tilt of the rotary support structure in a synchronized manner with signals from the sensor system, such that the inertial rotation structure uses the gravitational effect during the tilt of the rotary support structure.

21. The electric energy generator device of claim 1, further comprising a synchronization device for automatic operation in which the driving unit controls the rotary support structure such that it reaches maximum tilt after the inertial load exceeds a limit between the inertial load's ascendant rotation and the inertial load's descendent rotation over the rotary support structure.

22. The electric energy generator device of claim 1, further comprising a start up device, the start up device comprising:
the driving unit;
a connection to a sensor system of positional detection; and
a moving mechanism that moves the inertial rotation structure to a predetermined start up position.

23. The electric energy generator device of claim 22, wherein the moving mechanism includes a coupling and decoupling system that links the moving mechanism to the inertial rotation structure during start up.

24. The electric energy generator device of claim 1, further comprising a sensor system of positional detection that is connected to a start up device and to a synchronization device.

25. A method of operating the electric energy generator device of claim 1, the method comprising:
starting up the electric energy generator device;
controlling, through a sensor system, the position of the inertial rotation structure,
synchronizing the operation of the driving unit of the rotary support structure and the inertial rotation structure,
during extension of the driving unit, synchronizing in such a way that the driving unit reaches maximum extension after the inertial load exceeds the zenithal limit between the inertial load's ascendant rotation and inertial load's descendent rotation over the rotary support structure,
during retraction of the driving unit, synchronizing in such a way that the driving unit reaches maximum retraction after the inertial load exceeds the lower limit between the inertial load's descendent rotation and the inertial load's ascendant rotation over the rotary support structure; and
controlling the generation and delivery of electric energy.

26. The method of claim 25, wherein the starting up comprises:
activating a start up device;
controlling, through the sensor system, the position of the inertial rotation structure;
retracting the driving unit to reduce the tilt of the rotary support structure;
rotating, using a moving mechanism, the inertial rotation structure until the inertial rotation structure reaches a predetermined start up position that is beyond the zenithal limit and
extending the driving unit to increase the tilt of the rotary support structure such that the inertial rotation structure is influenced by the gravitational effect causing the inertial rotation structure to rotate over the rotary support structure.
